(19) United States
(12) Patent Application Publication
(10) Pub. No.: US 2009/0322727 A1
(43) Pub. Date: Dec. 31, 2009

(54) DISPLAY CONTROLLING APPARATUS AND DISPLAYING APPARATUS

(75) Inventor: Yoshiaki Iwashimizu, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/477,960

(22) Filed: Jun. 4, 2009

(30) Foreign Application Priority Data
Jun. 27, 2008 (JP) 2008-168888

(51) Int. Cl. G06F 3/038; H05B 37/02

(52) U.S. Cl. 345/212; 315/307

(57) ABSTRACT

A display controlling apparatus has a voltage controlling circuit configured to generate an output voltage signal based on image data. The voltage controlling circuit has a digital/analog converting unit configured to convert the image data into a voltage signal, a comparing unit configured to compare a prescripted voltage digital value and the image data, and an output voltage signal selecting unit configured to select a voltage signal as an output voltage signal based on comparison result of the comparing unit, the voltage signal corresponding to the prescripted voltage value or the voltage signal converted by the digital/analog converting unit.

### CROSS-REFERENCE TO RELATED APPLICATION

This application is based upon and claims the benefit of priority from the prior Japanese Patent Application No. 2008-168888, filed on Jun. 27, 2008; the entire contents of which are incorporated herein by reference.

### BACKGROUND OF THE INVENTION

### Field of the Invention

The present invention relates to a display controlling apparatus and a displaying apparatus, particularly to a display controlling apparatus used to control a gradation output voltage in a liquid crystal displaying system and a displaying apparatus provided with the display controlling apparatus.

An ordinary displaying apparatus such as an LCD (Liquid Crystal Display) includes a displaying module such as liquid crystal panel that displays an image and a display controlling apparatus such as an LCD driver that controls the displaying apparatus. A Digital/Analog (D/A) converter that performs a gradation output is provided in the display controlling apparatus. The D/A converter has a voltage adjusting function in which an output voltage is raised and lowered while a curve of an output voltage characteristic is maintained. Because a chromatic ability of a human is sensitive to an intermediate color while being insensitive to other colors, it is necessary that the output voltage be raised and lowered while the output voltage curve is maintained.

In a conventional display controlling apparatus, sometimes digital data that is equal to or larger than an assumed value is fed into the D/A converter when the output voltage is raised by the voltage adjusting function, and sometimes digital data that is equal to or smaller than an assumed value is fed into the D/A converter when the output voltage is lowered by the voltage adjusting function (see Japanese Patent Publication (laid-open) No. 2001-324966). In such cases, a voltage that is equal to or larger than the assumed value or equal to or smaller than the assumed value is applied to a transistor of the displaying apparatus. As a result, an operation of the displaying module becomes unstable. Further, when the voltage that is equal to or larger than the assumed value is applied to the transistor of the displaying module, the transistor of the displaying module is damaged and deteriorated.

That is, in the conventional display controlling apparatus, when the output voltage is raised and lowered by the voltage adjusting function, the operation of the displaying module cannot be stabilized while the output voltage curve is maintained within the range of the prescripted lower limit voltage to prescripted upper limit voltage.

### BRIEF SUMMARY OF THE INVENTION

According to an aspect of the present invention, there is provided a display controlling apparatus comprises a voltage controlling circuit configured to generate an output voltage signal based on image data, wherein the voltage controlling circuit comprises:

a digital/analog converting unit configured to convert the image data into a voltage signal;

a comparing unit configured to compare a prescripted voltage digital value and the image data; and

an output voltage signal selecting unit configured to select a voltage signal as an output voltage signal based on comparison result of the comparing unit, the voltage signal corresponding to the prescripted voltage value or the voltage signal converted by the digital/analog converting unit.

According to another aspect of the present invention, there is provided a display apparatus comprising:

a displaying module that displays an image; and

a display controlling apparatus configured to control the displaying module,

wherein the display controlling apparatus comprising:

a digital/analog converting unit configured to convert the image data into a voltage signal;

a comparing unit configured to compare a prescripted voltage digital value and the image data; and

an output voltage signal selecting unit configured to select a voltage signal as an output voltage signal based on comparison result of the comparing unit, the voltage signal corresponding to the prescripted voltage value or the voltage signal converted by the digital/analog converting unit, and the displaying module displays the image based on the output voltage signal supplied from the output voltage signal selecting unit.

### BRIEF DESCRIPTION OF THE DRAWINGS

FIG. 1 is a block diagram illustrating a configuration of a displaying apparatus of the first embodiment of the present invention.

FIG. 2 is a block diagram illustrating a configuration of the voltage controlling circuit 101 of FIG. 1.

FIG. 3 is a block diagram illustrating a configuration of the voltage detecting circuit 102 of FIG. 1.

FIG. 4 is a graph illustrating an output voltage characteristic of the voltage controlling circuit 101 of FIG. 1.

### DETAILED DESCRIPTION OF THE INVENTION

An exemplary embodiment of the invention will be described with reference to the drawings. The following embodiments are described only by way of example, and the scope of the invention is not limited to the embodiments.

The embodiment of the present invention is an example of a display controlling apparatus which has a characteristic of an output voltage that does not exceed predetermined upper limit and lower limit voltages.

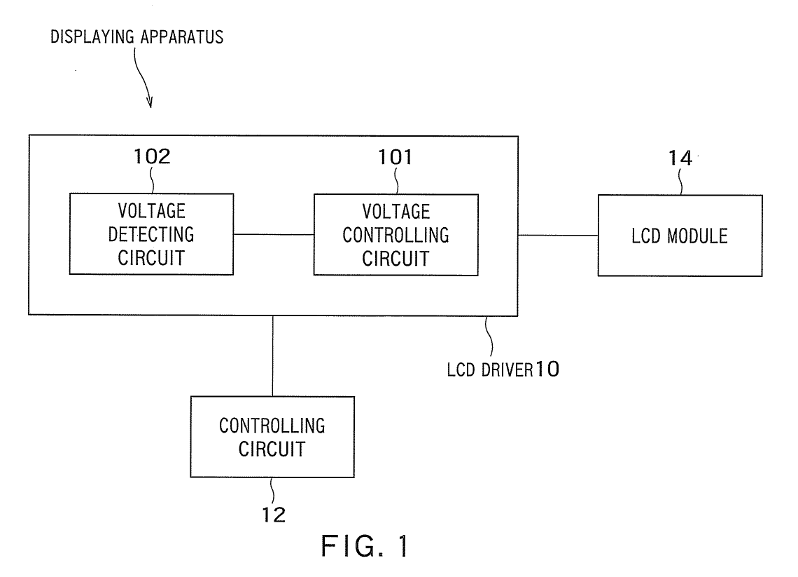

FIG. 1 is a block diagram illustrating a configuration of a displaying apparatus of the embodiment of the present invention.

The displaying apparatus includes an LCD driver 10, a controlling circuit 12, and an LCD module 14.

The LCD driver 10 is connected to the controlling circuit 12 and the LCD module 14. The LCD driver 10 is a display controlling apparatus configured to supply an output voltage signal for operating the LCD module 14 based on various control signals supplied from the controlling circuit 12. The LCD driver 10 includes a voltage controlling circuit 101 and a voltage detecting circuit 102. The voltage controlling circuit 101 generates an output voltage signal based on predetermined image data, and supplies the output voltage signal to the LCD module 14. The voltage detecting circuit 102 generates a prescripted upper limit voltage digital value 30 and a prescripted lower limit voltage digital value 31 by digital control, and supplies the prescripted upper limit voltage digital value 30 and the prescripted lower limit voltage digital value 31 to the voltage controlling circuit 101.

The controlling circuit 12 is connected to the LCD driver 10. The controlling circuit 12 supplies various control signals to the LCD driver 10. For example, the controlling circuit 12 is a computer connected to the LCD module 14. The computer starts up an application to perform various pieces of processing.

The LCD module 14 is connected to the LCD driver 10. The LCD module 14 is a displaying module including an LCD panel configured to display a predetermined image based on the output voltage signal supplied from the LCD driver 10.

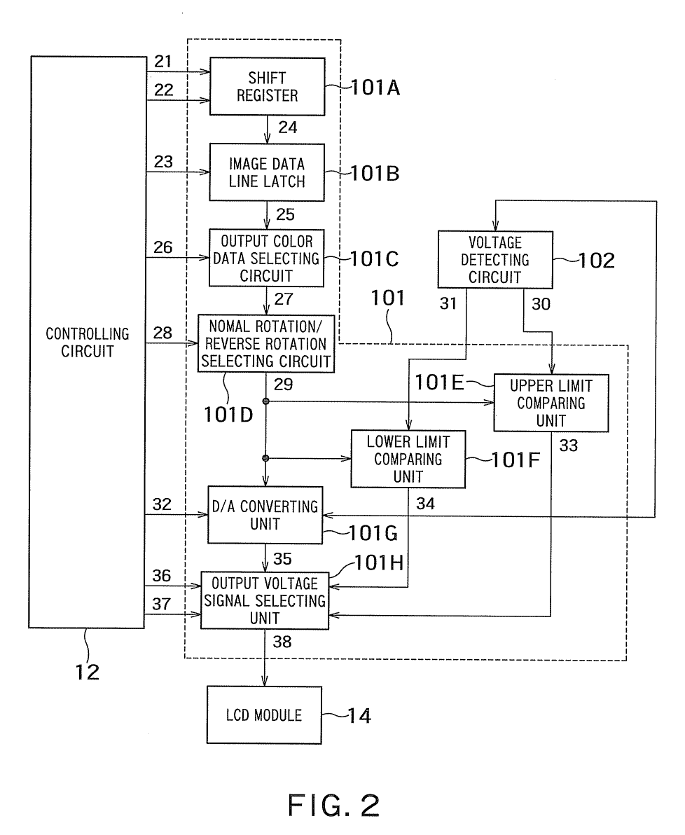

FIG. 2 is a block diagram illustrating a configuration of the voltage controlling circuit 101 of FIG. 1.

The voltage controlling circuit 101 includes a shift register 101A, an image data line latch 101B, an output color data selecting circuit 101C, a normal rotation/reverse rotation selecting circuit 101D, a comparing unit (maximum comparing unit 101E and minimum comparing unit 101F), a D/A converting unit 101G, and an output voltage signal selecting circuit 101H.

The shift register 101A captures one-line image data 21 in synchronization with a shift clock 22 supplied from the controlling circuit 12. The image data 21 includes pieces of data of colors, such as red, green, and blue, which constitute a pixel unit.

The image data line latch 101B captures an output data (image data) 24 of the shift register 101A in synchronization with an image data line latch clock 23 supplied from the controlling circuit 12 after the shift register 101A captures the one-line image data 21.

The image data line latch 101B supplies output data (image data) 25 to the output color data selecting circuit 101C, and the output color data selecting circuit 101C selects output color data of red, green, or blue using a D/A output color selecting signal 26 supplied from the controlling circuit 12. In the embodiment of the present invention, the output data 25 is a predetermined pixel unit (one pixel is a set of RGB) of data. That is, the output color data selecting circuit 101C selects the output color data in units of predetermined pixels at time intervals. For example, in cases where two pixels are a processing unit of the output color data selecting circuit 101C, in pieces of processing from processing performed by the normal rotation/reverse rotation selecting circuit 101D, RGB data (R1, G1, and B1) of a first pixel and RGB data (R2, G2, and B2) of a second pixel are sequentially processed while divided into six times as a whole.

The output color data selecting circuit 101C supplies output data (output color data) 27 to the normal rotation/reverse rotation selecting circuit 101D. The normal rotation/reverse rotation selecting circuit 101D normally or reversely rotates the output data 27 using a normal rotation/reverse rotation selecting signal 28 supplied from the controlling circuit 12.

The normal rotation/reverse rotation selecting circuit 101D supplies output data (normally rotated/reversely rotated output color data) 29 to the maximum comparing unit 101E, and the maximum comparing unit 101E compares the output data 29 and a prescripted upper limit voltage digital value 30 supplied from the voltage detecting circuit 102. In the embodiment of the present invention, the prescripted upper limit digital values 30 differ from color (red, blue, green) to color.

The normal rotation/reverse rotation selecting circuit 101D supplies the output data (normally rotated/reversely rotated output color data) 29 to the minimum comparing unit 101F, and the minimum comparing unit 101F compares the output data 29 and a prescripted lower limit voltage digital value 31 supplied from the voltage detecting circuit 102. In the embodiment of the present invention, the prescripted lower limit digital values 31 differ from color (red, blue, green) to color.

The normal rotation/reverse rotation selecting circuit 101D supplies the output data (normally rotated/reversely rotated output color data) 29 to the D/A converting unit 101G, and the controlling circuit 12 supplies a D/A output voltage adjusting signal 32 to the D/A converting unit 101G.

After the D/A converting unit 101G makes an adjustment using the D/A output voltage adjusting signal 32, converts the output data 29 into an analog signal (a D/A output voltage signal 35), and supplies the D/A output voltage signal 35 to the voltage signal selecting unit 101H.

A comparison result 33 of the maximum comparing unit 101E, a comparison result 34 of the minimum comparing unit 101F, the D/A output voltage signal 35 of the D/A converting unit 101G, and a prescripted upper limit voltage signal 36 and a prescripted lower limit voltage signal 37 which are supplied from the controlling circuit 12, are fed into the output voltage signal selecting unit 101H. The output voltage signal selecting unit 101H selects one of the D/A output voltage signal 35, the prescripted upper limit voltage signal 36, and the prescripted lower limit voltage signal 37 as an output voltage signal 38. At this point, in the case of “output data 29>prescripted upper limit voltage digital value 30” in the comparison result 33 of the maximum comparing unit 101E, the output voltage signal selecting unit 101H selects the prescripted upper limit voltage signal 36 as the output voltage signal 38. In the case of “output data 29<prescripted lower limit voltage digital value 31” in the comparison result 34 of the minimum comparing unit 101F, the output voltage signal selecting unit 101H selects the lower limit voltage signal 36 as the output voltage signal 38. In the case of “prescripted upper limit voltage digital value 30>output data 29>prescripted lower limit voltage digital value 31” in the comparison result 33 of the maximum comparing unit 101E and the comparison result 34 of the minimum comparing unit 101F, the output voltage signal selecting unit 101H selects the D/A output voltage signal 35 of the D/A converting unit 101G as the output voltage signal 38.

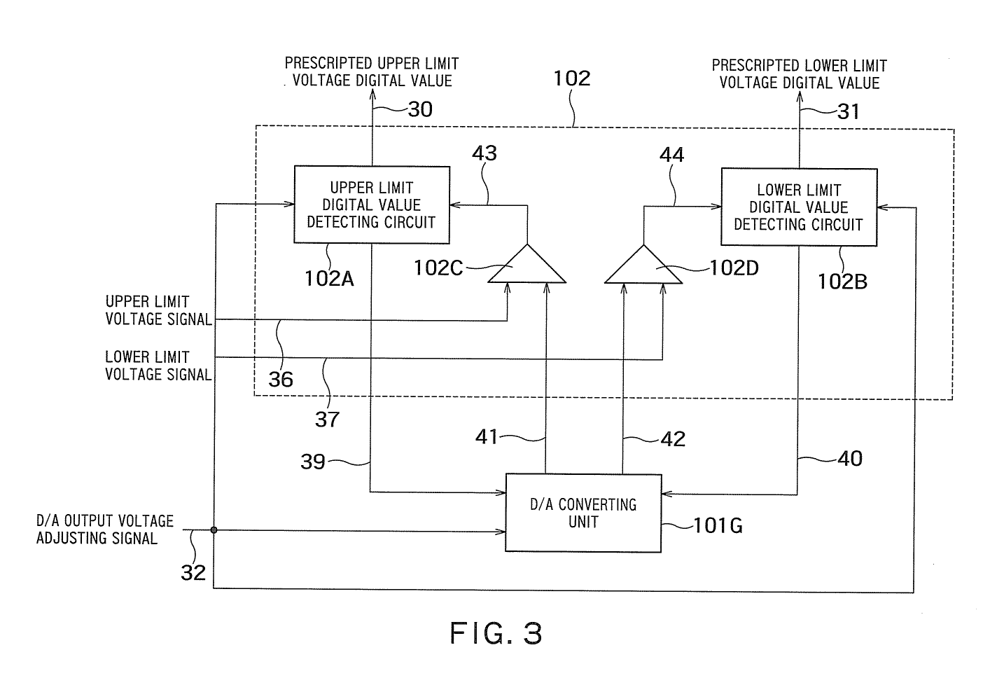

FIG. 3 is a block diagram illustrating a configuration of the voltage detecting circuit 102 of FIG. 1.

The voltage detecting circuit 102 includes a upper limit voltage digital value detecting circuit 102A, an lower limit voltage digital value detecting circuit 102B, and voltage comparators 102C and 102D.

The upper limit voltage digital value detecting circuit 102A and the lower limit voltage digital value detecting circuit 102B start the operations when the D/A output voltage adjusting signal 32 supplied from the controlling circuit 12 is changed. The upper limit voltage digital value detecting circuit 102A and the lower limit voltage digital value detecting circuit 102B supply predetermined input voltage digital values 39 and 40 to the D/A converting unit 101G of the voltage controlling circuit 101. At this point, in order to determine whether comparison results 43 and 44 of the voltage comparators 102C and 102D, the D/A converting unit 101G of the voltage controlling circuit 101 supplies voltage signals 41 and 42 corresponding to the input voltage digital values 39 and 40 supplied from the upper limit voltage digital value detecting circuit 102A and lower limit voltage digital value detecting circuit 102B to the voltage comparators 102C and 102D.

The voltage signal 41 supplied from the D/A converting unit 101G of the voltage controlling circuit 101 and the prescripted upper limit voltage signal 36 supplied from the controlling circuit 12 are fed into the voltage comparator 102C. The voltage comparator 102C compares the voltage signal 41 and the prescripted upper limit voltage signal 36. A comparison result 43 of the voltage comparator 102C initially becomes “voltage signal 41<prescripted upper limit voltage signal 36”, and the comparison result 43 is inverted at a certain moment.

The voltage signal 42 supplied from the D/A converting unit 101G of the voltage controlling circuit 101 and the prescripted lower limit voltage signal 37 supplied from the controlling circuit 12 are fed into the voltage comparator 102D. The voltage comparator 102D compares the voltage signal 42 and the prescripted lower limit voltage signal 37. A comparison result 44 of the voltage comparator 102D initially becomes “voltage signal 42>prescripted lower limit voltage signal 37”, and the comparison result 44 is inverted at a certain moment.

Then the comparison results 43 and 44 of the voltage comparators 102C and 102D are fed into the upper limit voltage digital value detecting circuit 102A and the lower limit voltage digital value detecting circuit 102B, respectively. The upper limit voltage digital value detecting circuit 102A and the lower limit voltage digital value detecting circuit 102B supply the input voltage digital values 39 and 40 to the voltage signal selecting unit 101H of the voltage controlling circuit 101 as the prescripted upper limit voltage digital value 30 and the prescripted lower limit voltage digital value 31 when the comparison results 43 and 44 are inverted.

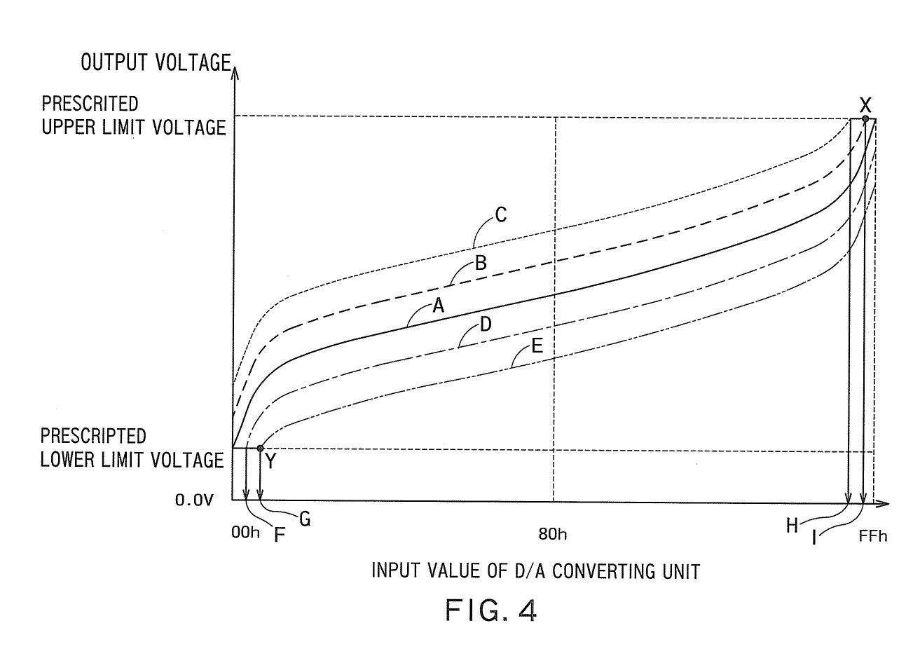

FIG. 4 is a graph illustrating an output voltage characteristic of the voltage controlling circuit 101 of FIG. 1.

A curve A shows an output voltage characteristic before the D/A converting unit 101G adjusts the output voltage. A curve B shows an output voltage characteristic when an adjustment range of the D/A output voltage adjusting signal 32 is set at a half of a maximum value. A curve C shows an output voltage characteristic when the adjustment range of the D/A output voltage adjusting signal 32 is set at the maximum value. A curve D shows an output voltage characteristic when the adjustment range of the D/A output voltage adjusting signal 32 is set at a half of a minimum value. A curve E shows an output voltage characteristic when the adjustment range of the D/A output voltage adjusting signal 32 is set at the minimum value.

For example, in cases where a user sets the adjustment range of the D/A output voltage adjusting signal 32 at the maximum value as illustrated by the curve C of the output voltage characteristic, the curve A of the output voltage characteristic is maintained in the range where the input value of the D/A converting unit 101G is equal to and lower than H, and a voltage (prescripted upper limit voltage) corresponding to the prescripted upper limit voltage signal 36 supplied from the controlling circuit 12 is maintained in the range where the input value of the D/A converting unit 101G is larger than H.

On the other hand, in cases where the user sets the adjustment range of the D/A output voltage adjusting signal 32 at the half of the minimum value as illustrated by the curve D of the output voltage characteristic, the curve A of the output voltage characteristic is maintained in the range where the input value of the D/A converting unit 101G is equal to and higher than F, and a voltage (minimum voltage) corresponding to the prescripted lower limit voltage signal 37 supplied from the controlling circuit 12 is maintained in the range where the input value of the D/A converting unit 101G is smaller than F.

In cases where the user sets the adjustment range of the D/A output voltage adjusting signal 32 at the half of the maximum value as illustrated by the curve B of the output voltage characteristic, because a magnitude correlation between the output voltage characteristic and the maximum voltage is inverted at a point X, the voltage detecting circuit 102 generates an input value I as the upper limit voltage digital value 30.

On the other hand, in cases where the user sets the adjustment range of the D/A output voltage adjusting signal 32 at the minimum value as illustrated by the curve E of the output voltage characteristic, because a magnitude correlation between the output voltage characteristic and the minimum voltage is inverted at a point Y, the voltage detecting circuit 102 generates an input value G as the lower limit voltage digital value 31.

In the embodiment of the present invention, the LCD driver 10 includes one voltage controlling circuit 101. Alternatively, the LCD driver 10 may include the plurality of voltage controlling circuits 101.

Alternatively, in the embodiment of the present invention, the controlling circuit 12 may adjust prescripted upper limit voltage 36 and the prescripted lower limit voltage 37 at arbitrary values.

In a modification of the embodiment, the output voltage signal selecting unit 101H may use the prescripted upper limit voltage and prescripted lower limit voltage generated in the LCD driver 10 instead of the prescripted upper limit voltage 36 and prescripted lower limit voltage 37 that are supplied from the controlling circuit 12. In such cases, the LCD driver 10 includes a voltage generating unit is configured to generate the prescripted upper limit voltage and the prescripted lower limit voltage. The voltage generating unit may adjust the prescripted upper limit voltage and the prescripted lower limit voltage at arbitrary values based on the control signal of the controlling circuit 12.

According to the embodiment of the present invention, the LCD driver 10 is configured to exert the output voltage characteristic. That is, the curve of the output voltage characteristic is maintained within the range of the prescripted upper limit voltage digital value to the prescripted lower limit voltage digital value, and the constant voltage corresponding to the prescripted upper limit voltage digital value or the prescripted lower limit voltage digital value is supplied out of the range of the prescripted upper limit voltage digital value and the prescripted lower limit voltage digital value. Therefore, the operation of the displaying module can be stabilized while the output voltage curve is maintained within the range of the prescripted lower limit voltage to the prescripted upper limit voltage.

According to the embodiment of the present invention, the voltage detecting circuit 102 generates the prescripted upper limit voltage digital value 30 and the prescripted lower limit voltage digital value 31 based on the curve of the output voltage characteristic of the D/A converting unit 101G. Therefore, the curve of the output voltage characteristic can be changed according to a type of the liquid crystal or a characteristic of human eyes without changing the design of the circuit configuration of the displaying apparatus. That is, even if the curve of the D/A output voltage characteristic is changed, because the voltage detecting circuit 102 generates the prescripted upper limit voltage digital value 30 and the prescripted lower limit voltage digital value 31, it is not necessary to mount a memory device such as ROM (Read Only Memory) in order to obtain the prescripted upper limit voltage digital value 30 and the prescripted lower limit voltage digital value 31. Particularly, in cases where a plurality of models of the liquid crystal display glass is developed for one model of an LCD driver, advantageously it is only necessary to change a display characteristic (y characteristic, that is, D/A output voltage curve) of the liquid crystal display glass.

According to the embodiment of the present invention, the output voltage applied to the transistor of the LCD module 14 is restrained to the prescripted upper limit voltage or less. Therefore, the reliability of the transistor of the LCD module 14 can be improved, and the damage of the transistor of the LCD module 14, which is caused by the application of the output voltage larger than the prescripted upper limit voltage, can be avoided.

According to the embodiment of the present invention, the prescripted upper limit voltage digital value 30 and the prescripted lower limit voltage digital value 31 are detected by the digital control, so that power consumption can be reduced compared with the case in which the prescripted upper limit voltage digital value 30 and the prescripted lower limit voltage digital value 31 are detected by the analog control.

According to the embodiment of the present invention, the prescripted upper limit voltage 36 and prescripted lower limit voltage 37 supplied from the controlling circuit 12 are used, so that the prescripted upper limit voltage 36 and the prescripted lower limit voltage 37 can be adjusted even after a clip is formed.

What is claimed is:

1. A display controlling apparatus comprising a voltage controlling circuit configured to generate an output voltage signal based on image data,
wherein the voltage controlling circuit comprises:
a digital/analog converting unit configured to convert the image data into a voltage signal;
a comparing unit configured to compare a prescripted voltage digital value and the image data; and
an output voltage signal selecting unit configured to select a voltage signal as an output voltage signal based on comparison result of the comparing unit, the voltage signal corresponding to the prescripted voltage value or the voltage signal converted by the digital/analog converting unit.

2. The apparatus of claim 1, wherein the comparing unit comprises a maximum comparing unit configured to compare a predetermined upper limit voltage digital value and the image data, and
the output voltage signal selecting unit selects a upper limit voltage signal corresponding to the upper limit voltage digital value as the output voltage signal when the image data is larger than the upper limit voltage value.

3. The apparatus of claim 2, wherein the comparing unit comprises a minimum comparing unit configured to compare a predetermined lower limit voltage digital value and the image data, and
the output voltage signal selecting unit selects an lower limit voltage signal corresponding to the lower limit voltage digital value as the output voltage signal when the image data is smaller than the lower limit voltage digital value.

4. The apparatus of claim 3, further comprising a voltage detecting circuit configured to supply the prescripted voltage digital value to the comparing unit based on the voltage signal supplied from the digital/analog converting unit.

5. The apparatus of claim 4, wherein the voltage detecting circuit comprises:
a voltage comparing unit configured to compare the voltage signal converted by the digital/analog converting unit and a prescripted voltage digital value; and
a voltage digital value detecting unit configured to supply an input voltage digital value as the prescripted voltage digital value to the voltage controlling circuit when comparison result of the voltage comparing unit is inverted, and
the comparing unit compares the prescripted voltage digital value supplied from the voltage detecting unit and the image data.

6. The apparatus of claim 1, wherein the comparing unit comprises a minimum comparing unit configured to compare a predetermined lower limit voltage digital value and the image data, and
the output voltage signal selecting unit selects an lower limit voltage signal corresponding to the lower limit voltage digital value as the output voltage signal when the image data is smaller than the lower limit voltage digital value.

7. The apparatus of claim 4, further comprising a voltage detecting circuit configured to supply the prescripted voltage digital value to the comparing unit based on the voltage signal supplied from the digital/analog converting unit.

8. The apparatus of claim 7, wherein the voltage detecting circuit comprises:
a voltage comparing unit configured to compare the voltage signal converted by the digital/analog converting unit and a prescripted voltage digital value; and
a voltage digital value detecting unit configured to supply an input voltage digital value as the prescripted voltage digital value to the voltage controlling circuit when comparison result of the voltage comparing unit is inverted, and
the comparing unit compares the prescripted voltage digital value supplied from the voltage detecting unit and the image data.

9. The apparatus of claim 1, further comprising a voltage detecting circuit configured to supply the prescripted voltage digital value to the comparing unit based on the voltage signal supplied from the digital/analog converting unit.

10. The apparatus of claim 9, wherein the voltage detecting circuit comprises:
a voltage comparing unit configured to compare the voltage signal converted by the digital/analog converting unit and a prescripted voltage digital value; and
a voltage digital value detecting unit configured to supply an input voltage digital value as the prescripted voltage digital value to the voltage controlling circuit when comparison result of the voltage comparing unit is inverted, and
the comparing unit compares the prescripted voltage digital value supplied from the voltage detecting unit and the image data.

11. A display apparatus comprising:
a displaying module that displays an image; and
a display controlling apparatus configured to control the displaying module,
wherein the display controlling apparatus comprising:
a digital/analog converting unit configured to convert the image data into a voltage signal;
a comparing unit configured to compare a prescripted voltage digital value and the image data; and
an output voltage signal selecting unit configured to select a voltage signal as an output voltage signal based on comparison result of the comparing unit, the voltage signal corresponding to the prescripted voltage value or the voltage signal converted by the digital/analog converting unit, and
the displaying module displays the image based on the output voltage signal supplied from the output voltage signal selecting unit.

12. The apparatus of claim 11, wherein the comparing unit comprises a maximum comparing unit configured to compare a predetermined upper limit voltage digital value and the image data, and
the output voltage signal selecting unit selects a upper limit voltage signal corresponding to the upper limit voltage digital value as the output voltage signal when the image data is larger than the upper limit voltage value.

13. The apparatus of claim 12, wherein the comparing unit comprises a minimum comparing unit configured to compare a predetermined lower limit voltage digital value and the image data, and
the output voltage signal selecting unit selects an lower limit voltage signal corresponding to the lower limit voltage digital value as the output voltage signal when the image data is smaller than the lower limit voltage digital value.

14. The apparatus of claim 13, further comprising a voltage detecting circuit configured to supply the prescripted voltage digital value to the comparing unit based on the voltage signal supplied from the digital/analog converting unit.

15. The apparatus of claim 14, wherein the voltage detecting circuit comprises:
a voltage comparing unit configured to compare the voltage signal converted by the digital/analog converting unit and a prescripted voltage digital value; and
a voltage digital value detecting unit configured to supply an input voltage digital value as the prescripted voltage digital value to the voltage controlling circuit when comparison result of the voltage comparing unit is inverted, and
the comparing unit compares the prescripted voltage digital value supplied from the voltage detecting unit and the image data.

16. The apparatus of claim 11, wherein the comparing unit comprises a minimum comparing unit configured to compare a predetermined lower limit voltage digital value and the image data, and
the output voltage signal selecting unit selects an lower limit voltage signal corresponding to the lower limit voltage digital value as the output voltage signal when the image data is smaller than the lower limit voltage digital value.

17. The apparatus of claim 14, further comprising a voltage detecting circuit configured to supply the prescripted voltage digital value to the comparing unit based on the voltage signal supplied from the digital/analog converting unit.

18. The apparatus of claim 17, wherein the voltage detecting circuit comprises:
a voltage comparing unit configured to compare the voltage signal converted by the digital/analog converting unit and a prescripted voltage digital value; and
a voltage digital value detecting unit configured to supply an input voltage digital value as the prescripted voltage digital value to the voltage controlling circuit when comparison result of the voltage comparing unit is inverted, and
the comparing unit compares the prescripted voltage digital value supplied from the voltage detecting unit and the image data.

19. The apparatus of claim 11, further comprising a voltage detecting circuit configured to supply the prescripted voltage digital value to the comparing unit based on the voltage signal supplied from the digital/analog converting unit.

20. The apparatus of claim 19, wherein the voltage detecting circuit comprises:
a voltage comparing unit configured to compare the voltage signal converted by the digital/analog converting unit and a prescripted voltage digital value; and
a voltage digital value detecting unit configured to supply an input voltage digital value as the prescripted voltage digital value to the voltage controlling circuit when comparison result of the voltage comparing unit is inverted, and
the comparing unit compares the prescripted voltage digital value supplied from the voltage detecting unit and the image data.
